(19) United States
(12) Patent Application Publication
(10) Pub. No.: US 2023/0395310 A1
(43) Pub. Date: Dec. 7, 2023

(54) COIL COMPONENT AND METHOD FOR MANUFACTURING THE SAME

(71) Applicant: Murata Manufacturing Co., Ltd., Kyoto-fu (JP)

(72) Inventor: Kota TAKAYAMA, Nagaokakyo-shi (JP)

(73) Assignee: Murata Manufacturing Co., Ltd., Kyoto-fu (JP)

(21) Appl. No.: 18/328,484

(22) Filed: Jun. 2, 2023

(30) Foreign Application Priority Data
Jun. 7, 2022 (JP) 2022-092475

(51) Int. Cl. H01F 27/29; H01F 17/04; H01F 41/06; H01F 27/28

(52) U.S. Cl. CPC H01F 27/292; H01F 17/045; H01F 41/06; H01F 27/2823

(57) ABSTRACT

A coil component includes a core including a winding core portion, and first and second flange portions at first and second ends, respectively, of the winding core portion. The coil component also includes first and second terminal electrodes on the first and second flange portions, respectively, and a wire wound around the winding core portion and including first and second end portions respectively connected to the first and second terminal electrodes. The first terminal electrode is at least on a first surface of the first flange portion. The first end portion of the wire is embedded in the first terminal electrode such that a part of the first end portion is exposed. The first terminal electrode includes a metal layer in which the first end portion is embedded and an alloy layer at least in a portion of a region between the metal layer and the first end portion.

### CROSS-REFERENCE TO RELATED APPLICATION

This application claims benefit of priority to Japanese Patent Application No. 2022-092475, filed Jun. 7, 2022, the entire content of which is incorporated herein by reference.

### BACKGROUND

### Technical Field

The present disclosure relates to a coil component and a method for manufacturing the coil component.

### Background Art

Japanese Unexamined Patent Application Publication No. 2017-162897 describes a known coil component. This coil component includes a core, a terminal electrode provided on the core, and a wire wound around the core and connected to the terminal electrode. The wire has an end portion embedded in the terminal electrode such that a part thereof is exposed.

It has been found that the bonding strength between the wire and the terminal electrode may be insufficient in actual use of the above-described known coil component.

### SUMMARY

Accordingly, the present disclosure provides a coil component with increased bonding strength between a wire and a terminal electrode and a method for manufacturing the coil component.

Therefore, a coil component according to an aspect of the present disclosure includes a core including a winding core portion, a first flange portion provided at a first end of the winding core portion, and a second flange portion provided at a second end of the winding core portion; a first terminal electrode provided on the first flange portion; a second terminal electrode provided on the second flange portion; and a wire wound around the winding core portion and including a first end portion connected to the first terminal electrode and a second end portion connected to the second terminal electrode. The first terminal electrode is provided at least on a first surface of the first flange portion. The first end portion of the wire is embedded in the first terminal electrode on the first surface of the first flange portion such that a part of the first end portion is exposed. The first terminal electrode includes a metal layer in which the first end portion is embedded and an alloy layer provided at least in a portion of a region between the metal layer and the first end portion. The alloy layer includes an alloy of a metal element included in the first end portion and a metal element included in the metal layer.

The structure in which a part of the first end portion is exposed means that the part of the first end portion is not covered by the first terminal electrode, and the part of the first end portion may be covered by another object.

According to the above-described aspect, the first terminal electrode includes the metal layer and the alloy layer, and the alloy layer is provided between the metal layer and the first end portion of the wire. The alloy layer includes an alloy of a metal element included in the first end portion and a metal element included in the metal layer. Accordingly, an alloy is provided at the interface between the first end portion of the wire and the metal layer of the first terminal electrode, and thus the bonding strength between the wire and the first terminal electrode can be increased.

Preferably, in the coil component according to an embodiment, the first end portion of the wire includes a first principal surface that faces the first surface and a second principal surface that is opposite to the first principal surface. A dimension of the first principal surface in a width direction is less than a dimension of the second principal surface in the width direction on a cross-section orthogonal to a direction in which the first end portion of the wire extends.

The cross-section orthogonal to the direction in which the first end portion of the wire extends is a cross-section orthogonal to a central axis of the wire at the first end portion of the wire. The dimension in the width direction is a dimension in a direction parallel to the first surface on the cross-section.

According to the above-described embodiment, when the first end portion of the wire is joined to the first terminal electrode by thermal pressure bonding by using a heater in manufacture of the coil component, heat applied to the second principal surface by the heater is transmitted such that the heat is concentrated at the first principal surface because the dimension of the first principal surface in the width direction is less than the dimension of the second principal surface in the width direction. This accelerates alloying at the interface between a part of the first end portion of the wire including the first principal surface and the metal layer of the first terminal electrode, so that the bonding strength between the wire and the first terminal electrode can be further increased. In addition, since the dimension of the second principal surface in the width direction is greater than the dimension of the first principal surface in the width direction, the visibility of the first end portion of the wire is increased. Accordingly, a test for confirming the position of the first end portion of the wire by using an image sensor, for example, is facilitated.

Preferably, in the coil component according to an embodiment, the first surface of the first flange portion is a surface that faces a mounting side. The first end portion of the wire includes a first principal surface that faces the first surface and a second principal surface that is opposite to the first principal surface. The first terminal electrode has an outer surface including a flat region that extends along the first surface and a fillet region that extends between the flat region and the first end portion of the wire. A portion of the fillet region that is connected to the first end portion of the wire is on the same plane as the second principal surface of the first end portion of the wire.

According to the above-described embodiment, when the first surface of the first flange portion is mounted on a mounting board, a mounting surface of the coil component includes the second principal surface of the first end portion of the wire and the fillet region of the first terminal electrode. Since a portion of the fillet region that is connected to the first end portion of the wire is on the same plane as the second principal surface of the first end portion of the wire, a connecting portion between the second principal surface of the first end portion of the wire and the fillet region of the first terminal electrode is smooth. Accordingly, the flatness of the mounting surface of the coil component can be increased, so that the mountability of the coil component can be improved.

Preferably, in the coil component according to an embodiment, the first surface of the first flange portion has a recess. At least a part of the first end portion of the wire overlaps the recess when viewed in a direction orthogonal to the first surface.

According to the above-described embodiment, at least a part of the first end portion of the wire overlaps the recess when viewed in a direction orthogonal to the first surface. Therefore, the first end portion of the wire can be easily positioned with respect to the first terminal electrode on the recess. Accordingly, the wire can be easily connected to the first terminal electrode.

Preferably, in the coil component according to an embodiment, at least a part of the first end portion of the wire is positioned in the recess.

According to the above-described embodiment, since at least a part of the first end portion of the wire is positioned in the recess, the first end portion of the wire can be more easily positioned with respect to the first terminal electrode on the recess. Accordingly, the wire can be more easily connected to the first terminal electrode.

Preferably, in the coil component according to an embodiment, the first surface of the first flange portion is a surface that faces a mounting side. The first terminal electrode has an outer surface including a flat region that extends along the first surface and a fillet region that extends between the flat region and the first end portion of the wire. The fillet region extends to a location outside the recess.

According to the above-described embodiment, since the fillet region extends to a location outside the recess, the inclination of the fillet region can be reduced. Accordingly, when the first surface of the first flange portion is mounted on the mounting board, the flatness of the fillet region included in the mounting surface of the coil component can be increased, so that the mountability of the coil component can be improved.

Preferably, in the coil component according to an embodiment, the first surface of the first flange portion is a surface that faces a mounting side. The first terminal electrode has an outer surface including a flat region that extends along the first surface and a fillet region that extends between the flat region and the first end portion of the wire. A dimension of the fillet region in a width direction is greater than a dimension of the first end portion of the wire in a height direction on a cross-section orthogonal to a direction in which the first end portion of the wire extends.

According to the above-described embodiment, since the dimension of the fillet region in the width direction is greater than the dimension of the first end portion of the wire in the height direction, the inclination of the fillet region can be reduced. Accordingly, when the first surface of the first flange portion is mounted on the mounting board, the flatness of the fillet region included in the mounting surface of the coil component can be increased, so that the mountability of the coil component can be improved.

Preferably, in the coil component according to an embodiment, the first end portion of the wire includes a first principal surface that faces the first surface and a second principal surface that is opposite to the first principal surface. The alloy layer is distributed more on the first-principal-surface side than on the second-principal-surface side with respect to a center line of the first end portion of the wire in a height direction on a cross-section orthogonal to a direction in which the first end portion of the wire extends.

According to the above-described embodiment, since the alloy layer is closer to the first principal surface than to the second principal surface, the bonding strength between the first end portion of the wire and the metal layer of the first terminal electrode can be increased at the first principal surface.

Preferably, a method for manufacturing a coil component according to an embodiment includes a terminal-electrode-forming step of providing a first terminal electrode on a first flange portion at a first end of a winding core portion of a core and providing a second terminal electrode on a second flange portion at a second end of the winding core portion; a wire winding step of winding a wire around the winding core portion of the core; and a wire connection step of connecting a first end portion of the wire to the first terminal electrode and connecting a second end portion of the wire to the second terminal electrode. The wire connection step includes placing the first end portion of the wire on the first terminal electrode and heating the first end portion of the wire while pressing the first end portion of the wire against the first terminal electrode with a heater so that the first end portion of the wire is embedded in a metal layer of the first terminal electrode and joined to the first terminal electrode by thermal pressure bonding in such a state that a dimension of a first principal surface of the first end portion of the wire in a width direction is less than a dimension of a second principal surface of the first end portion of the wire in the width direction on a cross-section orthogonal to a direction in which the first end portion of the wire extends. The first principal surface faces the first flange portion and the second principal surface being opposite to the first principal surface and pressed by the heater.

According to the above-described embodiment, when the first end portion of the wire is joined to the first terminal electrode by thermal pressure bonding by using the heater, heat applied to the second principal surface by the heater is transmitted such that the heat is concentrated at the first principal surface because the dimension of the first principal surface in the width direction is less than the dimension of the second principal surface in the width direction. This accelerates alloying at the interface between a part of the first end portion of the wire including the first principal surface and the metal layer of the first terminal electrode, so that the bonding strength between the wire and the first terminal electrode can be further increased.

According to the coil component and the method for manufacturing the coil component of the aspect of the present disclosure, the bonding strength between the wire and the terminal electrode can be increased.

### BRIEF DESCRIPTION OF THE DRAWINGS

FIG. 1 is a side view of a coil component according to a first embodiment;

FIG. 2 is a bottom view of the coil component;

FIG. 3 is a sectional view taken along line III-III in FIG. 2;

FIG. 4A is a sectional view illustrating a wire connection step;

FIG. 4B is a sectional view illustrating the wire connection step;

FIG. 5 is a bottom view of a coil component according to a second embodiment;

FIG. 6 is a sectional view taken along line VI-VI in FIG. 5;

FIG. 7 is a sectional view of a coil component according to a third embodiment; and

FIG. 8 is a side view of a coil component according to a fourth embodiment.

### DETAILED DESCRIPTION

Coil components according to an aspect of the present disclosure will be described in detail by way of embodiments illustrated in the drawings. The drawings including schematic illustrations do not necessarily reflect the actual dimensions and ratios.

### First Embodiment

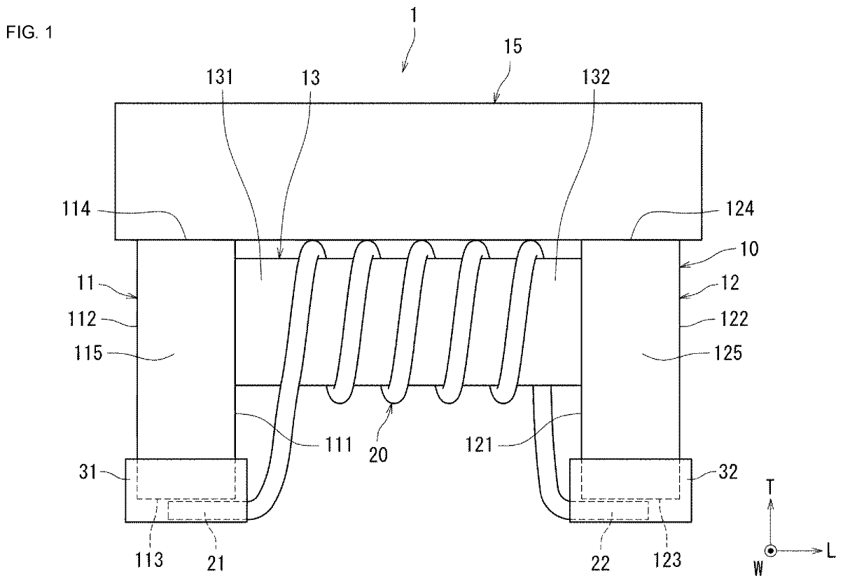

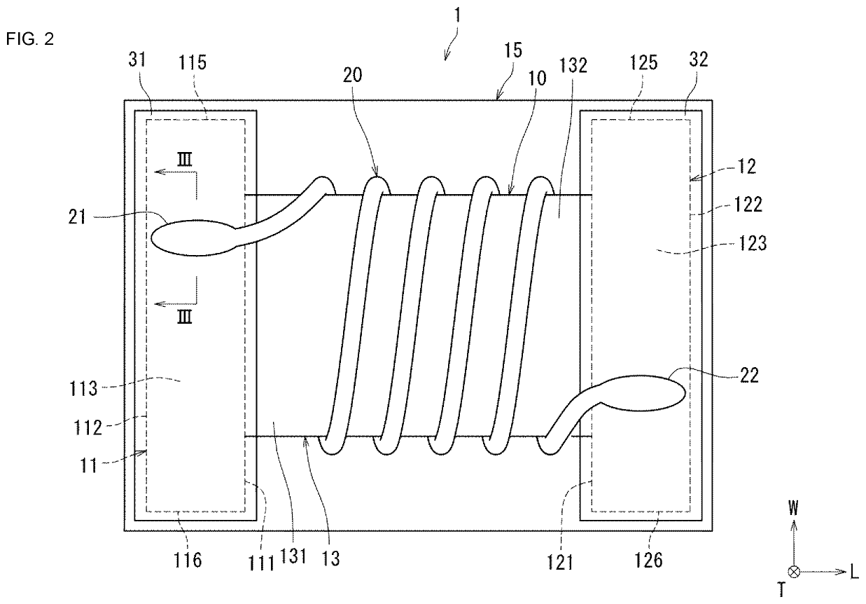

FIG. 1 is a side view of a coil component according to a first embodiment. FIG. 2 is a bottom view of the coil component. As illustrated in FIGS. 1 and 2, a coil component 1 includes a core 10; a first terminal electrode 31 and a second terminal electrode 32 provided on the core 10; a wire 20 wound around the core 10 and electrically connected to the first terminal electrode 31 and the second terminal electrode 32; and a plate member 15 attached to the core 10.

The core 10 includes a winding core portion 13 shaped to extend in a certain direction and having the wire 20 wound therearound; a first flange portion 11 that is provided at a first end 131 in a direction in which the winding core portion 13 extends and that extends orthogonally to this direction; and a second flange portion 12 that is provided at a second end 132 in the direction in which the winding core portion 13 extends and that extends orthogonally to this direction. The direction in which the winding core portion 13 extends is referred to also as an axial direction of the winding core portion 13. The material of the core 10 may preferably be, for example, a magnetic material, such as sintered ferrite or molded resin containing magnetic powder, or a non-magnetic material, such as alumina or resin.

In the following description, a bottom surface of the core 10 serves as a surface to be mounted on a mounting board, and a surface that is opposite to the bottom surface of the core 10 is a top surface of the core 10. A direction from the first flange portion 11 to the second flange portion 12 along the axial direction of the winding core portion 13 is an L direction. A direction orthogonal to the L direction on the bottom surface of the core 10 is a W direction. A direction from the bottom surface to the top surface of the core 10 is a T direction. The T direction is orthogonal to the L direction and the W direction. The W, L, and T directions arranged in that order from a right-handed system. The L direction is referred to also as a length direction of the core 10, the W direction as a width direction of the core 10, and the T direction as a height direction of the core 10.

In addition, a position “above” an element is not limited to a position separated from the element in an upward direction, that is, a position on the upper side of the element with another object or a gap therebetween, and includes a position that is in contact with and directly on the element. Also, the expression “upward relative to the element” does not mean a single absolute direction, such as a vertically upward direction defined by the direction of gravity, but means a direction that is outward, as opposed to inward, from the boundary defined by the element with reference to the element.

The winding core portion 13 has a rectangular shape in cross-section orthogonal to the axial direction. The cross-sectional shape of the winding core portion 13 may also be a polygonal shape other than a rectangular shape, such as a hexagonal shape, a circular shape, an elliptical shape, or a combination thereof.

The first flange portion 11 has an inner end surface 111 that faces the winding core portion 13; an outer end surface 112 that faces away from the inner end surface 111; a bottom surface 113 that connects the inner end surface 111 and the outer end surface 112 and faces the mounting board in a mounting process; a top surface 114 that faces away from the bottom surface 113; and two side surfaces, which are a first side surface 115 and a second side surface 116 that connect the inner end surface 111 and the outer end surface 112 and also connect the bottom surface 113 and the top surface 114.

The second flange portion 12 has an inner end surface 121 that faces the winding core portion 13; an outer end surface 122 that faces away from the inner end surface 121; a bottom surface 123 that faces the mounting board in the mounting process; a top surface 124 that faces away from the bottom surface 123; and two side surfaces, which are a first side surface 125 and a second side surface 126 that connect the inner end surface 121 and the outer end surface 122 and also connect the bottom surface 123 and the top surface 124.

The plate member 15 is fixed to extend over the first flange portion 11 and the second flange portion 12. The plate member 15 is attached to the top surface 114 of the first flange portion 11 and the top surface 124 of the second flange portion 12 with an adhesive. The material of the plate member 15 is, for example, the same as the material of the core 10. Since the core 10 and the plate member 15 are both made of a magnetic material, a closed magnetic circuit is formed, so that the efficiency in obtaining an inductance value is increased. Accordingly, the magnetic efficiency is increased, and the desired inductance value can be obtained with a small number of wires. Although the coil component 1 includes the plate member 15 in this embodiment, the plate member 15 may be omitted. Alternatively, a resin member may be used in place of the plate member 15.

The overall size of the coil component 1 including the core 10 and the plate member 15 may be, for example, 4.5 mm in the length direction (L direction), 3.2 mm in the width direction (W direction), and 3.5 mm in the height direction (T direction).

The wire 20 includes a conductive wire and a covering portion that covers the conductive wire. The conductive wire is made of, for example, a metal, such as copper, silver, or gold. The covering portion is made of a resin, such as polyurethane or polyamide-imide. The diameter of the wire 20 is, for example, 60 μm or more and 180 μm or less (i.e., from 60 μm to 180 μm).

A first end portion 21 of the wire 20 is electrically connected to the first terminal electrode 31, and a second end portion 22 of the wire 20 is electrically connected to the second terminal electrode 32. The wire 20 is connected to the first terminal electrode 31 and the second terminal electrode 32 by thermal pressure bonding. The first end portion 21 is a portion connected to the first terminal electrode 31 by thermal pressure bonding. At least a part of the covering part of the first end portion 21 is burnt out by heat applied in the thermal pressure bonding process. Therefore, the first end portion 21 is composed mainly of the conductive wire. The covering part of the first end portion 21 may be removed prior to the thermal pressure bonding process. Similarly, the second end portion 22 is a portion connected to the second terminal electrode 32 by thermal pressure bonding, and is composed mainly of the conductive wire.

The first terminal electrode 31 is provided at least on the bottom surface 113 of the first flange portion 11. More specifically, the first terminal electrode 31 covers the bottom surface 113 and parts of the inner end surface 111, the outer end surface 112, the first side surface 115, and the second side surface 116 that are adjacent to the bottom surface 113. The bottom surface 113 corresponds to the “first surface of the first flange portion” according to the claims.

Similarly, the second terminal electrode 32 is provided at least on the bottom surface 123 of the second flange portion 12. More specifically, the second terminal electrode 32 covers the bottom surface 123 and parts of the inner end surface 121, the outer end surface 122, the first side surface 125, and the second side surface 126 that are adjacent to the bottom surface 123.

When the coil component 1 is mounted on the mounting board, the bottom surface 113 of the first flange portion 11 and the bottom surface 123 of the second flange portion 12 face a mounting side. At this time, the axial direction of the winding core portion 13 is parallel to the principal surface of the mounting board. Thus, the coil component 1 is of a lateral type in which a winding axis of the wire 20 is parallel to the mounting board.

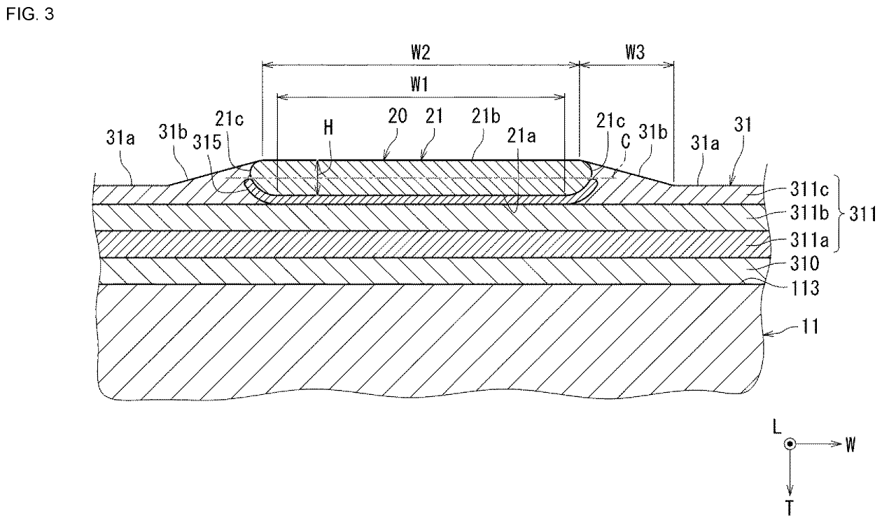

FIG. 3 is a sectional view taken along line III-III in FIG. 2. FIG. 3 is a sectional view taken in a direction orthogonal to a direction in which the first end portion 21 of the wire 20 extends. In other words, FIG. 3 illustrates a cross-section of the first end portion 21 of the wire 20 that is orthogonal to a central axis of the wire 20. Although the following description describes connection between the first end portion 21 of the wire 20 and the first terminal electrode 31, the description applies also to connection between the second end portion 22 of the wire 20 and the second terminal electrode 32.

As illustrated in FIGS. 2 and 3, the first end portion 21 of the wire 20 is embedded in the first terminal electrode 31 on the bottom surface 113 of the first flange portion 11 such that a part of the first end portion 21 is exposed.

The first terminal electrode 31 includes an underlying layer 310 that is in contact with the bottom surface 113 of the first flange portion 11, a metal layer 311 laminated on the underlying layer 310, and an alloy layer 315 provided at least in a portion of a region between the metal layer 311 and the first end portion 21. The first end portion 21 is embedded in the metal layer 311.

The underlying layer 310 is, for example, a sintered body obtained by applying conductive paste, such as Ag glass paste, by the dipping method and sintering the conductive paste. When the underlying layer 310 is a sintered body, the underlying layer 310 itself is strong and impact resistant. In addition, the underlying layer 310 and the first flange portion 11 can be strongly fixed together. The underlying layer 310 is, for example, an Ag layer having a low electrical resistance.

The metal layer 311 includes a first layer 311a, a second layer 311b, and a third layer 311c. The first layer 311a, the second layer 311b, and the third layer 311c are laminated upward in that order from the bottom surface 113 of the underlying layer 310. The first layer 311a, the second layer 311b, and the third layer 311c are plating layers formed by plating. The first layer 311a is, for example, a Cu layer that is made of Cu and conductive. The second layer 311b is, for example, a Ni layer that is made of Ni and resistant to solder leaching. The third layer 311c is, for example, a Sn layer that is made of Sn and that has a high wettability.

The underlying layer 310 has a thickness of, for example, 5 μm or more and 30 μm or less (i.e., from 5 μm to 30 μm). The first layer 311a has a thickness of, for example, 1 μm or more and 5 μm or less (i.e., from 1 μm to 5 μm). The second layer 311b has a thickness of, for example, 1 μm or more and 5 μm or less (i.e., from 1 μm to 5 μm). The third layer 311c has a thickness of, for example, 5 μm or more and 20 μm or less (i.e., from 5 μm to 20 μm).

The alloy layer 315 includes an alloy of a metal element included in the first end portion 21 of the wire 20 and metal elements included in the metal layer 311. The metal element included in the first end portion 21 of the wire 20 is a metal element included in the conductive wire of the first end portion 21. The metal elements included in the metal layer 311 are a metal element included in the second layer 311b and a metal element included in the third layer 311c.

More specifically, the first end portion 21 of the wire 20 is disposed on the second layer 311b and embedded in the third layer 311c. The alloy layer 315 is positioned at an interface between the first end portion 21 and the second layer 311b and an interface between the first end portion 21 and the third layer 311c.

A portion of the alloy layer 315 positioned at the interface between the first end portion 21 and the second layer 311b is made of, for example, an alloy of Cu and Ni, and has a thickness of, for example, 1 μm. A portion of the alloy layer 315 positioned at the interface between the first end portion 21 and the third layer 311c is made of, for example, an alloy of Cu and Sn, and has a thickness of, for example, 6 μm, which is greater than the thickness of the second layer 311b. The thicknesses of the alloy layer 315, the first layer 311a, the second layer 311b, and the third layer 311c in the drawings do not reflect the actual dimensions and ratios.

According to the above-described structure, the first terminal electrode 31 includes the metal layer 311 and the alloy layer 315, and the alloy layer 315 is provided between the metal layer 311 and the first end portion 21 of the wire 20. The alloy layer 315 includes an alloy of a metal element included in the first end portion 21 and a metal element included in the metal layer 311. Accordingly, an alloy is provided at the interface between the first end portion 21 of the wire 20 and the metal layer 311 of the first terminal electrode 31. In other words, the metal element included in the first end portion 21 and the metal element included in the second layer 311b are diffused into each other to form an alloy, and the metal element included in the first end portion 21 and the metal element included in the third layer 311c are also diffused into each other to form an alloy. Thus, the bonding strength between the wire 20 and the first terminal electrode 31 can be increased. Preferably, the alloy layer 315 includes both an alloy of Cu and Ni and an alloy of Cu and Sn so that the connection strength can be further increased. The layers included in the metal layer 311 are not limited to the three layers including the first layer 311a, the second layer 311b, and the third layer 311c, and the number thereof may be increased or reduced. In any case, the alloy layer 315 is formed at the interface between the first end portion 21 of the wire 20 and the metal layer 311.

Similarly, the second end portion 22 of the wire 20 is embedded in the second terminal electrode 32 on the bottom surface 123 (first surface) of the second flange portion 12 such that at least a part of the second end portion 22 is exposed. The second terminal electrode 32 includes a metal layer in which the second end portion 22 is embedded and an alloy layer provided at least in a portion of the region between the metal layer and the second end portion 22. The alloy layer includes an alloy of a metal element included in the second end portion 22 and a metal element included in the metal layer. Accordingly, the bonding strength between the wire 20 and the second terminal electrode 32 can be increased. Among the first terminal electrode 31 and the second terminal electrode 32, at least the first terminal electrode 31 includes the alloy layer.

As illustrated in FIG. 3, the first end portion 21 of the wire 20 includes a first principal surface 21a that faces the bottom surface 113, a second principal surface 21b that is opposite to the first principal surface 21a, and side surfaces 21c that connect the first principal surface 21a and the second principal surface 21b. The first principal surface 21a and the second principal surface 21b are flat and parallel to each other. The side surfaces 21c are convex and project toward a region outside the first end portion 21. The first end portion 21 has a flat shape in cross-section.

A dimension of the first principal surface 21a in the width direction (hereinafter referred to as a width W1 of the first principal surface 21a) is less than a dimension of the second principal surface 21b in the width direction (hereinafter referred to as a width W2 of the second principal surface 21b) on a cross-section orthogonal to the direction in which the first end portion 21 of the wire 20 extends. A dimension in the width direction is a dimension in a direction parallel to the bottom surface 113 on the cross-section (W direction).

For example, the width W1 of the first principal surface 21a is 180 μm and the width W2 of the second principal surface 21b is 200 μm on the cross-section orthogonal to the direction in which the first end portion 21 of the wire 20 extends and passing through the center of the length of the first end portion 21 of the wire 20 in the direction in which the first end portion 21 of the wire 20 extends. A dimension of the first end portion 21 of the wire 20 in the height direction (hereinafter referred to as a height H of the first end portion 21) is 15 μm. A widest portion between the two side surfaces 21c and 21c is positioned above and closer to the second principal surface 21b than the center of the height H of the wire 20 (center line C).

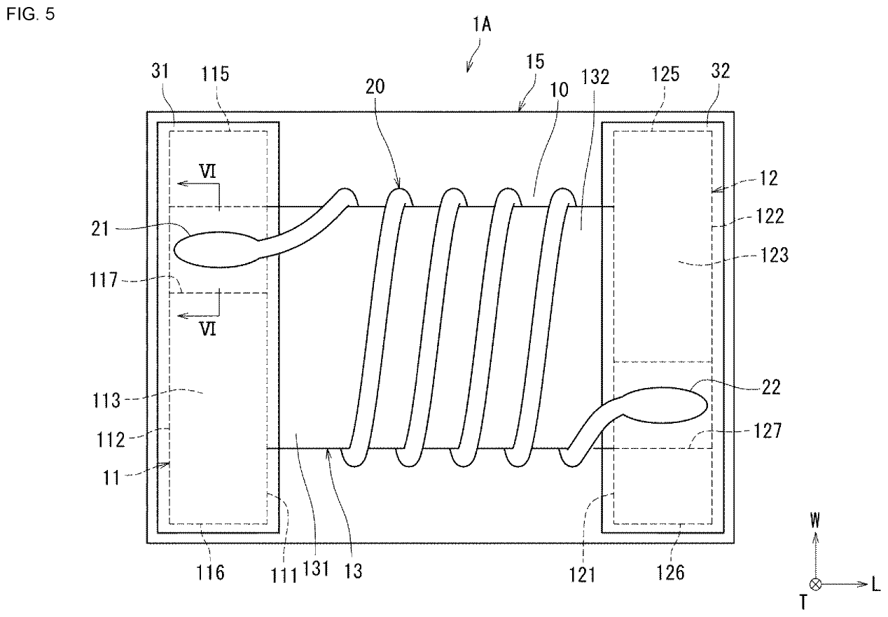

Referring to FIG. 5, when the bottom surface 113 of the first flange portion 11 has a recess 117 and when the first end portion 21 of the wire 20 overlaps the recess 117, a direction in which the recess 117 extends is substantially the same as the direction in which the first end portion 21 of the wire 20 extends in a bottom view of the coil component. In this case, the cross-section orthogonal to the direction in which the first end portion 21 of the wire 20 extends is, for example, a cross-section that passes through the center of the length of the recess 117 in the direction in which the recess 117 extends. In FIG. 5, the direction in which the recess 117 extends is the same as the L direction. When the direction in which the recess 117 extends is inclined with respect to the L direction in a bottom view of the coil component, the direction in which the first end portion 21 of the wire 20 extends is also inclined with respect to the L direction in a bottom view of the coil component. Also in this case, the cross-section orthogonal to the direction in which the first end portion 21 of the wire 20 extends (direction inclined with respect to the L direction) is, for example, a cross-section that passes through the center of the length of the recess 117 in the direction in which the recess 117 extends (direction inclined with respect to the L direction).

According to the above-described structure, when the first end portion 21 of the wire 20 is joined to the first terminal electrode 31 by thermal pressure bonding by using a heater in manufacture of the coil component 1, heat applied to the second principal surface 21b by the heater is transmitted such that the heat is concentrated at the first principal surface 21a because the width W1 of the first principal surface 21a is less than the width W2 of the second principal surface 21b. This accelerates alloying at the interface between a part of the first end portion 21 of the wire 20 including the first principal surface 21a and the metal layer 311 of the first terminal electrode 31, so that the bonding strength between the wire 20 and the first terminal electrode 31 can be further increased. More specifically, alloying at the interface between the first principal surface 21a of the first end portion 21 and the second layer 311b is accelerated, and alloying at the interface between a portion of each side surface 21c of the first end portion 21 that is adjacent to the first principal surface 21a and the third layer 311c is also accelerated.

In addition, since the width W2 of the second principal surface 21b is greater than the width W1 of the first principal surface 21a, the visibility of the first end portion 21 of the wire 20 is increased. Accordingly, a test for confirming the position of the first end portion 21 of the wire 20 by using an image sensor, for example, is facilitated.

Similarly, the second end portion 22 of the wire 20 includes a first principal surface that faces the bottom surface 123 of the second flange portion 12 and a second principal surface that is opposite to the first principal surface. A dimension of the first principal surface in the width direction is less than a dimension of the second principal surface in the width direction on a cross-section orthogonal to a direction in which the second end portion 22 of the wire 20 extends. This accelerates alloying at the interface between a part of the second end portion 22 of the wire 20 including the first principal surface and the metal layer of the second terminal electrode 32, so that the bonding strength between the wire 20 and the second terminal electrode 32 can be further increased. Among the first end portion 21 and the second end portion 22, at least the first end portion 21 is structured such that the width of the first principal surface is less than the width of the second principal surface.

As illustrated in FIG. 3, the first terminal electrode 31 has an outer surface including a flat region 31a and fillet regions 31b extending between the flat region 31a and the first end portion 21 of the wire 20. The flat region 31a is a surface extending along the bottom surface 113. Each fillet region 31b is an inclined surface whose height continuously increases from the flat region 31a to the first end portion 21 of the wire 20. Each fillet region 31b may include a concave curved surface. A portion of each fillet region 31b that is connected to the first end portion 21 of the wire 20 is preferably on the same plane as the second principal surface 21b of the first end portion 21 of the wire 20.

According to the above-described structure, when the bottom surface 113 of the first flange portion 11 is mounted on the mounting board, a mounting surface of the coil component 1 includes the second principal surface 21b of the first end portion 21 of the wire 20 and the fillet regions 31b of the first terminal electrode 31. Since the portion of each fillet region 31b that is connected to the first end portion 21 of the wire 20 is on the same plane as the second principal surface 21b of the first end portion 21 of the wire 20, connecting portions between the second principal surface 21b of the first end portion 21 of the wire 20 and the fillet regions 31b of the first terminal electrode 31 are smooth. Accordingly, the flatness of the mounting surface of the coil component 1 can be increased, so that the mountability of the coil component 1 can be improved.

Similarly, the second terminal electrode 32 has an outer surface including a flat region extending along the bottom surface 123 and fillet regions extending between the flat region and the second end portion 22 of the wire 20. A portion of each fillet region that is connected to the second end portion 22 of the wire 20 is preferably on the same plane as the second principal surface of the second end portion 22 of the wire 20. Accordingly, the flatness of the mounting surface of the coil component 1 can be increased, so that the mountability of the coil component 1 can be improved. Among the first terminal electrode 31 and the second terminal electrode 32, at least the first terminal electrode 31 is structured such that the connecting portion of each fillet region is on the same plane as the second principal surface of the wire.

As illustrated in FIG. 3, a dimension of each fillet region 31b in the width direction (hereinafter referred to as a width W3 of the fillet region 31b) is preferably greater than the height H of the first end portion 21 of the wire 20 on the cross-section orthogonal to the direction in which the first end portion 21 of the wire 20 extends.

According to the above-described structure, the inclination of the fillet regions 31b can be reduced. Therefore, when the bottom surface 113 of the first flange portion 11 is mounted on the mounting board, the flatness of the fillet regions 31b included in the mounting surface of the coil component 1 can be increased, so that the mountability of the coil component 1 can be improved.

Similarly, the width of each fillet region on the outer surface of the second terminal electrode 32 is preferably greater than the height of the second end portion 22 of the wire 20. Accordingly, the flatness of the mounting surface of the coil component 1 can be increased, so that the mountability of the coil component 1 can be improved. Among the first terminal electrode 31 and the second terminal electrode 32, at least the first terminal electrode 31 is structured such that the width of each fillet region is greater than the height of the wire end portion.

As illustrated in FIG. 3, the alloy layer 315 is preferably distributed more on the first-principal-surface-21a side than on the second-principal-surface-21b side with respect to the center line C of the first end portion 21 of the wire 20 in the height direction (T direction) on the cross-section orthogonal to the direction in which the first end portion 21 of the wire 20 extends. Here, the expression “distributed more on the first-principal-surface-21a side” means that the alloy layer 315 is unevenly distributed to be distributed more on the first-principal-surface-21a side, and the alloy layer 315 may include a portion that is provided on the second-principal-surface-21b side.

According to the above-described structure, the bonding strength between the first end portion 21 of the wire 20 and the metal layer 311 of the first terminal electrode 31 can be increased on the first-principal-surface-21a side.

Similarly, the alloy layer of the second terminal electrode 32 is preferably distributed more on the first-principal-surface side than on the second-principal-surface side with respect to a center line of the second end portion 22 of the wire 20 in the height direction. Accordingly, the bonding strength between the second end portion 22 of the wire 20 and the metal layer of the second terminal electrode 32 can be increased on the first-principal-surface side. Among the first terminal electrode 31 and the second terminal electrode 32, at least the first terminal electrode 31 is structured such that the alloy layer is distributed more on the first-principal-surface side than on the second-principal-surface side.

A method for manufacturing the coil component 1 will now be described.

Referring to FIG. 2, the first terminal electrode 31 is formed on the first flange portion 11 at the first end 131 of the winding core portion 13 of the core 10, and the second terminal electrode 32 is formed on the second flange portion 12 at the second end 132 of the winding core portion 13 (hereinafter referred to as a terminal-electrode-forming step). After the terminal-electrode-forming step, the wire 20 is wound around the winding core portion 13 of the core 10 (hereinafter referred to as a wire winding step). After the wire winding step, the first end portion 21 of the wire 20 is connected to the first terminal electrode 31, and the second end portion 22 of the wire 20 is connected to the second terminal electrode 32 (hereinafter referred to as a wire connection step).

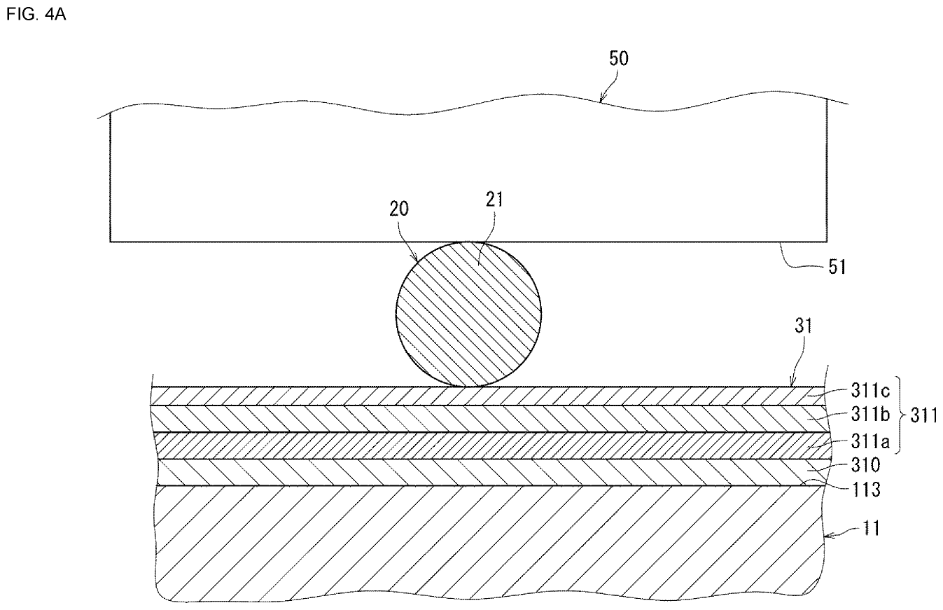

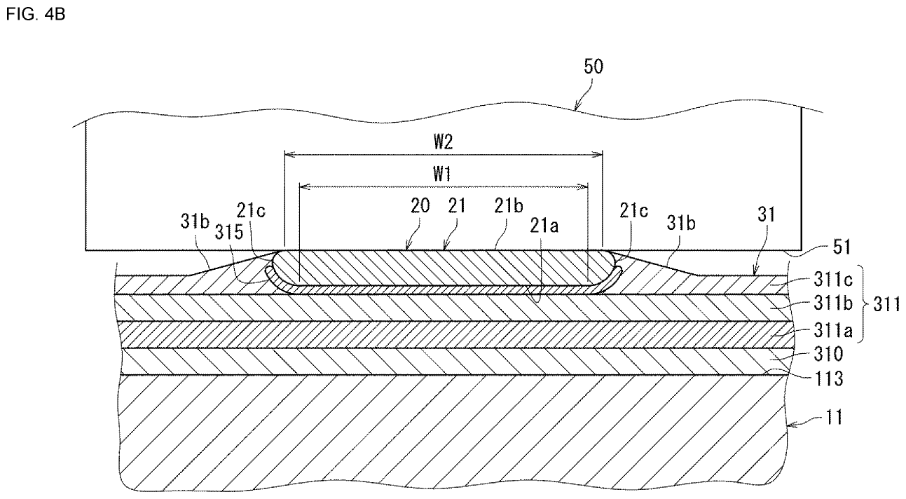

Referring to FIG. 4A, in the wire connection step, the first end portion 21 of the wire 20 is placed on the first terminal electrode 31, and is pressed against the first terminal electrode 31 and heated by a pressing surface 51 of a heater 50. As a result, as illustrated in FIG. 4B, the first end portion 21 and the first terminal electrode 31 (metal layer 311) are melted and deformed by heat and pressure applied by the heater 50. Thus, the first end portion 21 is joined to the first terminal electrode 31 by thermal pressure bonding.

In this process, the first end portion 21 of the wire 20 is embedded in the metal layer 311 of the first terminal electrode 31 and joined to the first terminal electrode 31 by thermal pressure bonding in such a state that the width W1 of the first principal surface 21a of the first end portion 21 of the wire 20 is less than the width W2 of the second principal surface 21b of the first end portion 21 of the wire 20, which is pressed by the heater 50, on the cross-section orthogonal to the direction in which the first end portion 21 of the wire 20 extends.

In the thermal pressure bonding process, for example, the heater 50 is set to a temperature of 500° C., and pressure is applied for 1 second. After that, the temperature of the heater 50 is reduced to 300° C. in 1 second while pressure is continuously applied, and then the heater 50 is moved upward. Thus, sufficient heat is applied to the wire 20 and the metal layer 311, so that an alloy is formed at the interface between the first end portion 21 of the wire 20 and the metal layer 311 of the first terminal electrode 31. When the heater 50 applies pressure, the pressure applied to the wire 20 by the heater 50 is gradually reduced so that the width W1 of the first principal surface 21a of the wire 20 is less than the width W2 of the second principal surface 21b of the wire 20.

According to the above-described structure, when the first end portion 21 of the wire 20 is joined to the first terminal electrode 31 by thermal pressure bonding by using the heater, heat applied to the second principal surface 21b by the heater 50 is transmitted such that the heat is concentrated at the first principal surface 21a because the width W1 of the first principal surface 21a is less than the width W2 of the second principal surface 21b. This accelerates alloying at the interface between a part of the first end portion 21 of the wire 20 including the first principal surface 21a and the metal layer 311 of the first terminal electrode 31, so that the bonding strength between the wire 20 and the first terminal electrode 31 can be further increased.

Similarly, in the wire connection step, the second end portion of the wire is placed on the second terminal electrode, and is pressed against the second terminal electrode and heated by the heater. Thus, the second end portion of the wire is embedded in the metal layer of the second terminal electrode and joined to the second terminal electrode by thermal pressure bonding in such a state that the dimension of the first principal surface of the second end portion of the wire in the width direction is less than the dimension of the second principal surface of the second end portion of the wire in the width direction on a cross-section orthogonal to the direction in which the second end portion of the wire extends. The first principal surface faces the second flange portion, and the second principal surface is opposite to the first principal surface and is pressed by the heater. Among the first terminal electrode 31 and the second terminal electrode 32, at least the first terminal electrode 31 is structured such that the end portion of the wire is embedded in the metal layer of the terminal electrode and joined to the terminal electrode by thermal pressure bonding in such a state that the width of the first principal surface of the end portion of the wire is less than the width of the second principal surface of the end portion of the wire.

### Second Embodiment

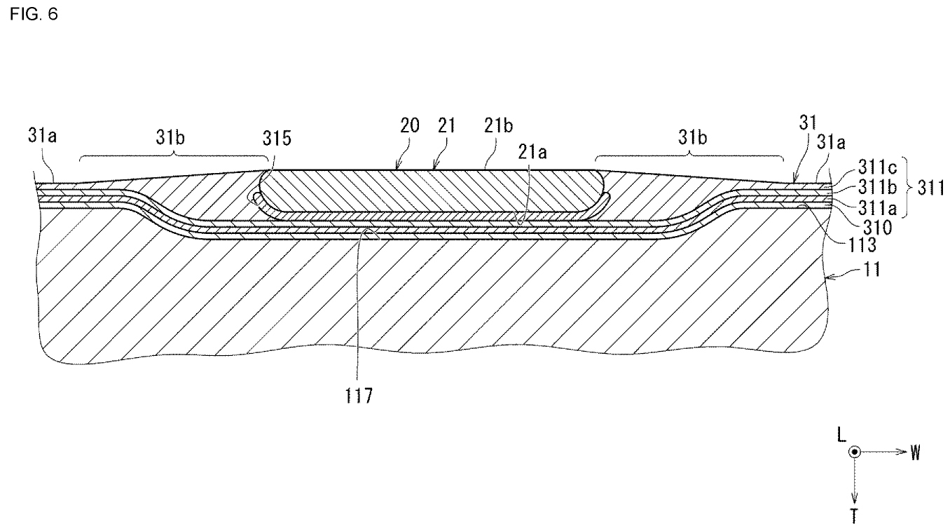

FIG. 5 is a bottom view of a coil component according to a second embodiment. FIG. 6 is a sectional view taken along line VI-VI in FIG. 5. The second embodiment differs from the first embodiment in that the first flange portion and the second flange portion have recesses. The difference will now be described. Other structures are the same as those of the first embodiment, and description thereof will be omitted.

As illustrated in FIG. 5, in a coil component 1A according to the second embodiment, the bottom surface 113 of the first flange portion 11 has the recess 117. At least a part of the first end portion 21 of the wire 20 overlaps the recess 117 when viewed in a direction orthogonal to the bottom surface 113.

The recess 117 extends in the L direction. The recess 117 opens in the inner end surface 111, the outer end surface 112, and the bottom surface 113. The depth of the recess 117 continuously increases, for example, from the outer end surface 112 to the inner end surface 111. Alternatively, the depth of the recess 117 may be constant or continuously decrease from the outer end surface 112 to the inner end surface 111.

Similarly, the bottom surface 123 of the second flange portion 12 has a recess 127. At least a part of the second end portion 22 of the wire 20 overlaps the recess 127 when viewed in a direction orthogonal to the bottom surface 123. The structure of the recess 127 is similar to that of the recess 117. The recess 117 and the recess 127 are symmetrical to each other about a center point of the coil component 1A when viewed in the direction orthogonal to the bottom surface 123.

According to the above-described structure, at least a part of the first end portion 21 of the wire 20 overlaps the recess 117 when viewed in the direction orthogonal to the bottom surface 113. Therefore, the first end portion 21 of the wire 20 can be easily positioned with respect to the first terminal electrode 31 on the recess 117. More specifically, the first terminal electrode 31 has a recessed shape that follows the shape of the recess 117, and therefore the first end portion 21 of the wire 20 can be easily positioned with respect to the recessed portion of the first terminal electrode 31. Accordingly, the wire 20 can be easily connected to the first terminal electrode 31. Similarly, at least a part of the second end portion 22 of the wire 20 overlaps the recess 127 when viewed in the direction orthogonal to the bottom surface 123. Therefore, the wire 20 can be easily connected to the second terminal electrode 32. Among the first flange portion 11 and the second flange portion 12, at least the first flange portion 11 has the recess.

As illustrated in FIG. 6, the fillet regions 31b of the first terminal electrode 31 preferably extend to locations outside the recess 117 on the cross-section orthogonal to the direction in which the first end portion 21 of the wire 20 extends. According to the above-described structure, the inclination of the fillet regions 31b can be reduced. Therefore, when the bottom surface 113 of the first flange portion 11 is mounted on the mounting board, the flatness of the fillet regions 31b included in the mounting surface of the coil component 1A can be increased, so that the mountability of the coil component 1A can be improved.

Similarly, the fillet regions of the second terminal electrode 32 preferably extend to locations outside the recess 127 on the cross-section orthogonal to the direction in which the second end portion 22 of the wire 20 extends. Accordingly, the inclination of the fillet regions can be reduced, so that the flatness of the mounting surface of the coil component 1A can be increased and the mountability of the coil component 1A can be improved. Among the first terminal electrode 31 and the second terminal electrode 32, at least the first terminal electrode 31 is structured such that the fillet regions extend to locations outside the recess.

As illustrated in FIG. 6, the first end portion 21 of the wire 20 is positioned above and outward from the recess 117. In other words, the first principal surface 21a of the first end portion 21 of the wire 20 is positioned above the recess 117. More specifically, the first principal surface 21a of the first end portion 21 of the wire 20 is positioned below the second layer 311b at an opening edge of the recess 117, and the second principal surface 21b of the first end portion 21 of the wire 20 is positioned above the second layer 311b at the opening edge of the recess 117. The depth of the recess 117 may be increased or the thickness of the first terminal electrode 31 may be reduced so that at least a part of the first end portion 21 of the wire 20 is positioned in the recess 117. In this case, the first principal surface 21a of the first end portion 21 of the wire 20 is positioned below the opening edge of the recess 117. Accordingly, the first end portion 21 of the wire 20 can be more easily positioned with respect to the first terminal electrode 31 on the recess 117. Thus, the wire 20 can be more easily connected to the first terminal electrode 31.

Similarly, the second terminal electrode 32 may be structured such that at least a part of the second end portion 22 of the wire 20 is positioned in the recess 127. Accordingly, the second end portion 22 of the wire 20 can be more easily positioned with respect to the second terminal electrode 32 on the recess 127, and the wire 20 can be more easily connected to the second terminal electrode 32. Among the first terminal electrode 31 and the second terminal electrode 32, at least the first terminal electrode 31 is structured such that at least a part of the end portion of the wire is positioned in the recess.

### Third Embodiment

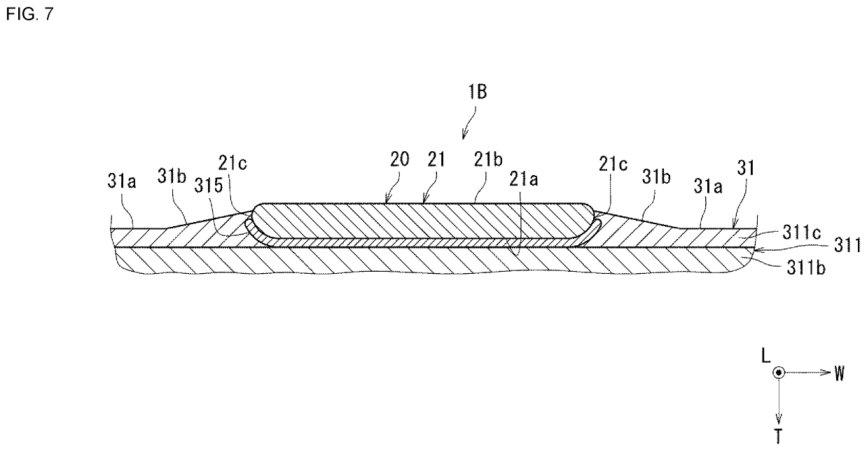

FIG. 7 is a sectional view of a coil component according to a third embodiment. FIG. 7 is a sectional view corresponding to FIG. 3. The third embodiment differs from the first embodiment in the shape of the outer surface of the first terminal electrode. The difference will now be described. Other structures are the same as those of the first embodiment, and description thereof will be omitted.

As illustrated in FIG. 7, in a coil component 1B according to the third embodiment, a portion of each fillet region 31b that is connected to the first end portion 21 of the wire 20 is positioned below the second principal surface 21b of the first end portion 21 of the wire 20 on the outer surface of the first terminal electrode 31. In other words, the fillet regions 31b are connected to the side surfaces 21c of the first end portion 21 of the wire 20.

According to the above-described structure, an upper part of the first end portion 21 of the wire 20 projects from the outer surface of the first terminal electrode 31. Therefore, the visibility of the first end portion 21 of the wire 20 is increased, and a test for confirming the position of the first end portion 21 of the wire 20 by using an image sensor, for example, is facilitated.

Similarly, a portion of each fillet region that is connected to the second end portion 22 of the wire 20 is preferably positioned below the second principal surface of the second end portion 22 of the wire 20 on the outer surface of the second terminal electrode 32. Accordingly, the visibility of the second end portion 22 of the wire 20 is increased, and a test for confirming the position of the second end portion 22 of the wire 20 by using an image sensor, for example, is facilitated. Among the first terminal electrode 31 and the second terminal electrode 32, at least the first terminal electrode 31 is structured such that the connecting portion of the fillet region is positioned below the second principal surface of the wire.

Similarly to the first embodiment, the coil component 1B according to the third embodiment may be manufactured by adjusting the heating temperature and variation in the applied pressure in the pressure bonding process.

### Fourth Embodiment

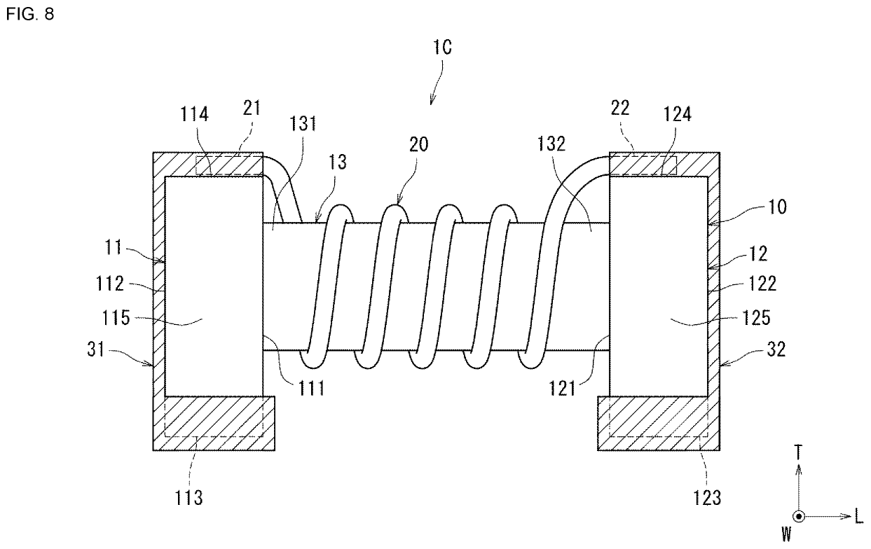

FIG. 8 is a side view of a coil component according to a fourth embodiment. The fourth embodiment differs from the first embodiment in positions at which the wire is connected. The difference will now be described. Other structures are the same as those of the first embodiment, and description thereof will be omitted. In FIG. 8, the first terminal electrode 31 and the second terminal electrode 32 are hatched for convenience.

As illustrated in FIG. 8, in a coil component 1C according to the fourth embodiment, the first terminal electrode 31 continuously extends along the top surface 114, the outer end surface 112, and the bottom surface 113 of the first flange portion 11. The first end portion 21 of the wire 20 is embedded in the first terminal electrode 31 on the top surface 114 of the first flange portion 11 such that a part of the first end portion 21 is exposed. The top surface 114 corresponds to the “first surface of the first flange portion” according to the claims. The bottom surface 113 is a surface that faces the mounting side.

Similarly, the second terminal electrode 32 continuously extends along the top surface 124, the outer end surface 122, and the bottom surface 123 of the second flange portion 12. The second end portion 22 of the wire 20 is embedded in the second terminal electrode 32 on the top surface 124 of the second flange portion 12 such that a part of the second end portion 22 is exposed. The bottom surface 123 is a surface that faces the mounting side.

According to the above-described structure, each of the first terminal electrode 31 and the second terminal electrode 32 is formed such that a connecting position at which the wire 20 is connected differs from a mounting position for mounting on the mounting board. Therefore, the coil component 1C can be mounted in a stable manner at the mounting positions irrespective of the state of connection of the wire 20. In addition, the wire 20 can be smoothly connected to the first terminal electrode 31 and the second terminal electrode 32. Therefore, when a plate member is attached to the top surface 114 of the first flange portion 11 and the top surface 124 of the second flange portion 12, the inclination of the plate member can be reduced. In this case, although the plate member covers the first end portion 21 and the second end portion 22 of the wire 20, the first end portion 21 is exposed at the first terminal electrode 31, and the second end portion 22 is exposed at the second terminal electrode 32. Among the first terminal electrode 31 and the second terminal electrode 32, at least the first terminal electrode 31 is structured such that the connecting position at which the wire 20 is connected differs from the mounting position for mounting on the mounting board.

The present disclosure is not limited to the above-described embodiments, and design changes are possible without departing from the gist of the present disclosure. For example, features of the first to fourth embodiments may be combined in various ways.

Although one wire and two terminal electrodes are provided in the above-described embodiments, the numbers of wires and terminal electrodes may be increased.

Although the first end portion of the wire is connected to the bottom surface or the top surface of the first flange portion in the above-described embodiments, the first end portion of the wire may be connected to the inner end surface, the outer end surface, the first side surface, or the second side surface of the first flange portion. This also applies to the second end portion of the wire.

Although the bottom surface of the first flange portion is the surface that faces the mounting side in the above-described embodiments, a surface of the first flange portion other than the bottom surface may be the surface that faces the mounting side.

Although each terminal electrode includes an underlying layer and a metal layer in the above-described embodiments, the underlying layer may be a metal terminal. In this case, the metal layer is formed by plating on the metal terminal made of Cu, for example, and the metal terminal is fixed to the core with an adhesive or the like. The use of such a metal terminal contributes to an increase in durability.
<1> A coil component comprising a core including a winding core portion, a first flange portion provided at a first end of the winding core portion, and a second flange portion provided at a second end of the winding core portion; a first terminal electrode provided on the first flange portion; a second terminal electrode provided on the second flange portion; and a wire wound around the winding core portion and including a first end portion connected to the first terminal electrode and a second end portion connected to the second terminal electrode. The first terminal electrode is provided at least on a first surface of the first flange portion. The first end portion of the wire is embedded in the first terminal electrode on the first surface of the first flange portion such that a part of the first end portion is exposed. The first terminal electrode includes a metal layer in which the first end portion is embedded and an alloy layer provided at least in a portion of a region between the metal layer and the first end portion, and the alloy layer includes an alloy of a metal element included in the first end portion and a metal element included in the metal layer.
<2> The coil component according to <1>, wherein the first end portion of the wire includes a first principal surface that faces the first surface and a second principal surface that is opposite to the first principal surface, and a dimension of the first principal surface in a width direction is less than a dimension of the second principal surface in the width direction on a cross-section orthogonal to a direction in which the first end portion of the wire extends.
<3> The coil component according to <1> or <2>, wherein the first surface of the first flange portion is a surface that faces a mounting side, and the first end portion of the wire includes a first principal surface that faces the first surface and a second principal surface that is opposite to the first principal surface. Also, the first terminal electrode has an outer surface including a flat region that extends along the first surface and a fillet region that extends between the flat region and the first end portion of the wire, and a portion of the fillet region that is connected to the first end portion of the wire is on the same plane as the second principal surface of the first end portion of the wire.
<4> The coil component according to any one of <1> to <3>, wherein the first surface of the first flange portion has a recess, and at least a part of the first end portion of the wire overlaps the recess when viewed in a direction orthogonal to the first surface.
<5> The coil component according to <4>, wherein at least a part of the first end portion of the wire is positioned in the recess.
<6> The coil component according to <4> or <5>, wherein the first surface of the first flange portion is a surface that faces a mounting side, the first terminal electrode has an outer surface including a flat region that extends along the first surface and a fillet region that extends between the flat region and the first end portion of the wire, and the fillet region extends to a location outside the recess.
<7> The coil component according to any one of <1> to <6>, wherein the first surface of the first flange portion is a surface that faces a mounting side, the first terminal electrode has an outer surface including a flat region that extends along the first surface and a fillet region that extends between the flat region and the first end portion of the wire, and a dimension of the fillet region in a width direction is greater than a dimension of the first end portion of the wire in a height direction on a cross-section orthogonal to a direction in which the first end portion of the wire extends.
<8> The coil component according to any one of <1> to <7>, wherein the first end portion of the wire includes a first principal surface that faces the first surface and a second principal surface that is opposite to the first principal surface, and the alloy layer is distributed more on the first-principal-surface side than on the second-principal-surface side with respect to a center line of the first end portion of the wire in a height direction on a cross-section orthogonal to a direction in which the first end portion of the wire extends.
<9> A method for manufacturing a coil component, the method comprising a terminal-electrode-forming step of providing a first terminal electrode on a first flange portion at a first end of a winding core portion of a core and providing a second terminal electrode on a second flange portion at a second end of the winding core portion; a wire winding step of winding a wire around the winding core portion of the core; and a wire connection step of connecting a first end portion of the wire to the first terminal electrode and connecting a second end portion of the wire to the second terminal electrode. The wire connection step includes placing the first end portion of the wire on the first terminal electrode and heating the first end portion of the wire while pressing the first end portion of the wire against the first terminal electrode with a heater so that the first end portion of the wire is embedded in a metal layer of the first terminal electrode and joined to the first terminal electrode by thermal pressure bonding in such a state that a dimension of a first principal surface of the first end portion of the wire in a width direction is less than a dimension of a second principal surface of the first end portion of the wire in the width direction on a cross-section orthogonal to a direction in which the first end portion of the wire extends. The first principal surface faces the first flange portion and the second principal surface being opposite to the first principal surface and pressed by the heater.

What is claimed is:

1. A coil component comprising:
a core including a winding core portion, a first flange portion at a first end of the winding core portion, and a second flange portion at a second end of the winding core portion;
a first terminal electrode on the first flange portion;
a second terminal electrode on the second flange portion; and
a wire wound around the winding core portion and including a first end portion connected to the first terminal electrode and a second end portion connected to the second terminal electrode,
wherein
the first terminal electrode is at least on a first surface of the first flange portion,
the first end portion of the wire is embedded in the first terminal electrode on the first surface of the first flange portion such that a portion of the first end portion is exposed,
the first terminal electrode includes a metal layer in which the first end portion is embedded and an alloy layer in at least a portion of a region between the metal layer and the first end portion, and
the alloy layer includes an alloy of a metal element included in the first end portion of the wire and a metal element included in the metal layer of the first terminal electrode.

2. The coil component according to claim 1, wherein
the first end portion of the wire includes a first principal surface that faces the first surface of the first flange portion and a second principal surface that is opposite to the first principal surface, and
a dimension of the first principal surface in a width direction is smaller than a dimension of the second principal surface in the width direction on a cross-section orthogonal to a direction in which the first end portion of the wire extends.

3. The coil component according to claim 1, wherein
the first surface of the first flange portion is a surface that faces a mounting side,
the first end portion of the wire includes a first principal surface that faces the first surface of the first flange portion and a second principal surface that is opposite to the first principal surface,
the first terminal electrode has an outer surface including a flat region that extends along the first surface of the first flange portion and a fillet region that extends between the flat region and the first end portion of the wire, and
a portion of the fillet region that is connected to the first end portion of the wire is on a same plane as the second principal surface of the first end portion of the wire.

4. The coil component according to claim 1, wherein
the first surface of the first flange portion has a recess, and
at least a portion of the first end portion of the wire overlaps the recess when viewed in a direction orthogonal to the first surface.

5. The coil component according to claim 4, wherein
at least the portion of the first end portion of the wire is positioned in the recess.

6. The coil component according to claim 4, wherein
the first surface of the first flange portion is a surface that faces a mounting side,
the first terminal electrode has an outer surface including a flat region that extends along the first surface and a fillet region that extends between the flat region and the first end portion of the wire, and
the fillet region extends outside the recess.

7. The coil component according to claim 1, wherein
the first surface of the first flange portion is a surface that faces a mounting side,
the first terminal electrode has an outer surface including a flat region that extends along the first surface and a fillet region that extends between the flat region and the first end portion of the wire, and
a dimension of the fillet region in a width direction is greater than a dimension of the first end portion of the wire in a height direction on a cross-section orthogonal to a direction in which the first end portion of the wire extends.

8. The coil component according to claim 1, wherein
the first end portion of the wire includes a first principal surface that faces the first surface of the first flange portion and a second principal surface that is opposite to the first principal surface, and
the alloy layer is distributed more on a side of the first principal surface than on a side of the second principal surface with respect to a center line of the first end portion of the wire in a height direction on a cross-section orthogonal to a direction in which the first end portion of the wire extends.

9. The coil component according to claim 2, wherein
the first surface of the first flange portion is a surface that faces a mounting side,
the first end portion of the wire includes a first principal surface that faces the first surface of the first flange portion and a second principal surface that is opposite to the first principal surface,
the first terminal electrode has an outer surface including a flat region that extends along the first surface of the first flange portion and a fillet region that extends between the flat region and the first end portion of the wire, and
a portion of the fillet region that is connected to the first end portion of the wire is on a same plane as the second principal surface of the first end portion of the wire.

10. The coil component according to claim 2, wherein
the first surface of the first flange portion has a recess, and
at least a portion of the first end portion of the wire overlaps the recess when viewed in a direction orthogonal to the first surface.

11. The coil component according to claim 10, wherein
at least the portion of the first end portion of the wire is positioned in the recess.

12. The coil component according to claim 10, wherein
the first surface of the first flange portion is a surface that faces a mounting side,
the first terminal electrode has an outer surface including a flat region that extends along the first surface and a fillet region that extends between the flat region and the first end portion of the wire, and
the fillet region extends outside the recess.

13. The coil component according to claim 2, wherein
the first surface of the first flange portion is a surface that faces a mounting side,
the first terminal electrode has an outer surface including a flat region that extends along the first surface and a fillet region that extends between the flat region and the first end portion of the wire, and
a dimension of the fillet region in a width direction is greater than a dimension of the first end portion of the wire in a height direction on a cross-section orthogonal to a direction in which the first end portion of the wire extends.

14. The coil component according to claim 2, wherein
the first end portion of the wire includes a first principal surface that faces the first surface of the first flange portion and a second principal surface that is opposite to the first principal surface, and
the alloy layer is distributed more on a side of the first principal surface than on a side of the second principal surface with respect to a center line of the first end portion of the wire in a height direction on a cross-section orthogonal to a direction in which the first end portion of the wire extends.

15. A method for manufacturing a coil component, the method comprising:
providing a first terminal electrode on a first flange portion at a first end of a winding core portion of a core and providing a second terminal electrode on a second flange portion at a second end of the winding core portion of the core;
winding a wire around the winding core portion of the core; and
connecting a first end portion of the wire to the first terminal electrode and connecting a second end portion of the wire to the second terminal electrode,
wherein the connecting includes
placing the first end portion of the wire on the first terminal electrode and heating the first end portion of the wire by a heater while pressing the first end portion of the wire toward the first terminal electrode,
embedding the first end portion of the wire in a metal layer of the first terminal electrode and thermal-pressure bonding the first end portion of the wire to the first terminal electrode, in such a state that a dimension in a width direction of a first principal surface of the first end portion of the wire is smaller than a dimension in the width direction of a second principal surface of the first end portion of the wire on a cross-section orthogonal to a direction in which the first end portion of the wire extends, wherein the first principal surface faces the first flange portion, the second principal surface is opposite to the first principal surface, and the second principal surface is a surface which is to be pressed by the heater.
